(19) United States
(12) Patent Application Publication
(10) Pub. No.: US 2026/0048522 A1
(43) Pub. Date: Feb. 19, 2026

(54) Autonomous Precision Object Opening Systems and Methods

(71) Applicant: Robotica, Inc., Cypress, TX (US)

(72) Inventor: Jay Mark Dugat, Cypress, TX (US)

(73) Assignee: Robotica, Inc., Cypress, TX (US)

(21) Appl. No.: 19/301,964

(22) Filed: Aug. 16, 2025

Related U.S. Application Data
(60) Provisional application No. 63/684,440, filed on Aug. 19, 2024.

(51) Int. Cl. B26D 5/00; B65B 69/00

(52) U.S. Cl. CPC B26D 5/005; B26D 5/007; B65B 69/0033

(57) ABSTRACT

Assemblies for cutting objects including a platform with a cutting element linked to the platform. The platform configured with an electro-actuation clutch for selective movement of the platform. Wherein movement of the platform via actuation of the electro-actuation clutch enables manipulation of the cutting element. A method for cutting objects.

### CROSS-REFERENCE TO RELATED APPLICATIONS

This application claims priority from U.S. Provisional Application No. 63/684,440 filed on Aug. 19, 2024, incorporated herein by reference in its entirety.

### FIELD OF THE INVENTION

The present disclosure relates generally to technology for autonomously opening objects, such as containers, without damaging the contents therein.

### BACKGROUND

The growing trend in shipping boxes towards tighter tolerances presents a significant challenge in box opening automation design. The precision required to cut open the box without damaging the contents is higher than ever, adding complexity to the process. Boxes are not square or rectilinear and often have distortions or damage, forcing dimensional technology to measure them in ever-higher resolutions over an extensive range of sizes. With dimensional technologies at their limit, additional methods are required to achieve the box opening accuracy and precision needed to cut boxes accurately, preventing damage to contents.

Attempts to provide higher precision have led to expensive, bulky tools, which limit their ability to navigate a wide range of box sizes. Furthermore, the industry's conventional tooling cannot automatically adopt its settings as boxes arrive in random order and size without creating a vast database beforehand. Box opening processes must continue without significant delays or interruptions in multi-shift warehouse operations, where the box volume is higher than ever. Conventional tools require changing the cutting element during operation as the cutting component becomes dull or loses its ability to open the box properly. This necessitates a system shutdown for manual changes or massive and costly tool changes that require manual servicing outside the opening machine, disrupting the workflow and reducing productivity.

Automated container opening systems use machinery or robotics to open containers without human intervention. However, damage rates to the contents inside the containers remain high from automated openers cutting into the product. Product damage works against the justification of automation. Cost savings and efficiencies in packaging design have shrunk clearance inside the container between the contents and the container walls. Shipping and handling shape distortion to the container challenge the technologies available for automating container opening without damage. If the cut depth is shallow, the box will likely not open. If the cut line, as measured from the top of the box, is too low, damage to the contents is likely. The box is expected not to be correctly opened if the cut line is high.

Damage to contents happens because the cut is in the wrong place and too deep. Box measuring technologies are not accurate enough to produce the precision required. On the other hand, if a box is cut too shallow or has a cut line too high, it will not open and requires manual attention to correct the automation fault. Cut recipes were created to pre-program different cut depths and heights and train them for particular box sizes and styles. Modern warehouses can have thousands of box configurations for automated opening, making creating and maintaining a cut database difficult and time-consuming. The cost of maintaining the database works against the justification of the opening automation.

Cut settings are not the only problem. Box opening automation damages the contents of hundreds of boxes because boxes are not square, with straight sides, or rectilinear. Every box is different—even those from the same die. Shipping, handling, and the original erection process cause actual sizes of the same box to vary as much as 10 mm. FIG. 1 shows a typical box 1 in comparison to a box 2 with straight or square walls. The typical box 1 has rounded corners 3, bulging sides 4 from crushing, stacking or overpackaging, and sides 5 that are not square.

Conventional technologies for cutting containers have been proposed in U.S. Patent references 11,550,301, 11,794,370, 11,806,825, 2020/0339298, 2023/0241695, 2024/0009877, and 2024/0025000. Nonetheless, the proposed technologies have drawbacks and limitations. A need remains for improved container cutting technologies.

### SUMMARY

An aspect of this disclosure is an assembly for cutting objects, including a platform; a cutting element linked to the platform; the platform configured with an electro-actuation clutch for selective movement of the platform; and wherein movement of the platform via actuation of the electro-actuation clutch enables manipulation of the cutting element.

Another aspect of this disclosure is a method for cutting objects, including actuating an electro-actuation clutch to selectively move a platform, wherein movement of the platform enables manipulation of a cutting element linked to the platform; setting the platform proximate an object; and cutting a surface of the object with the cutting element.

Another aspect of this disclosure is a method for cutting objects, including determining a wall thickness of an object; calculating a cutting path for the object in real time based on the determined wall thickness; and manipulating a platform configured with a cutting element to cut the object along the calculated cutting path.

### BRIEF DESCRIPTION OF THE DRAWINGS

The following figures form part of the present specification and are included to further demonstrate certain aspects of the present disclosure and should not be used to limit or define the claimed subject matter. The claimed subject matter may be better understood by reference to one or more of these drawings in combination with the description of embodiments disclosed herein. Consequently, a more complete understanding of the present embodiments and further features and advantages thereof may be acquired by referring to the following description taken in conjunction with the accompanying drawings, in which like reference numerals may identify like elements.

FIG. 1 shows a schematic of a conventional container overlaid in comparison with an ideal container.

FIG. 2 shows a perspective view of a cutter assembly providing automatic and autonomous horizontal axis adjustment according to an example of the present disclosure.

FIG. 3 shows a side view of another cutter assembly according to an example of the present disclosure.

FIG. 4 shows a cross-section schematic of cutter assembly platforms configured with an electric clutch according to an example of the present disclosure.

FIG. 5 shows a schematic of a manipulator engaged to a cutter assembly cutting an object according to an example of the present disclosure.

FIG. 6 shows a schematic of a cutting element depth penetration setting for cutting an object according to an example of the present disclosure.

FIG. 7 shows an overhead view of cutter assembly according to an example of the present disclosure.

FIG. 8 shows a perspective view of a cutter assembly providing automatic and autonomous vertical and horizontal axes adjustment according to an example of the present disclosure.

FIG. 9 shows the cutter assembly of FIG. 8 cutting an object according to an example of the present disclosure.

FIG. 10 shows a close-up view of the cutter assembly of FIG. 8 cutting an object according to an example of the present disclosure.

FIG. 11 shows a perspective view of another cutter assembly providing automatic and autonomous horizontal axis adjustment according to an example of the present disclosure.

FIG. 12 shows a side view of the cutter assembly of FIG. 11.

FIG. 13 shows a schematic of a cutter assembly in the process of automatic and autonomous replacement of a cutting element according to an example of the present disclosure.

FIG. 14A shows a schematic sequence of events for autonomous replacement of a cutting element in a cutter assembly according to an example of the present disclosure.

FIG. 14B shows a schematic sequence of the continued events from FIG. 14A for autonomous replacement of a cutting element in a cutter assembly.

FIG. 15 shows a perspective view of another cutter assembly providing automatic and autonomous horizontal axis adjustment according to an example of the present disclosure.

FIG. 16 shows a schematic of the cutter assembly of FIG. 15 engaged on a torque station for automatic and autonomous adjustment of a cut depth in the horizontal plane according to an example of the present disclosure.

FIG. 17 shows a schematic of the cutter assembly of FIG. 15 cutting an object according to an example of the present disclosure.

FIG. 18 shows a perspective front view of another cutter assembly providing automatic and autonomous adjustment of the cutting element orientation according to an example of the present disclosure.

FIG. 19 shows a perspective rear view of the cutter assembly of FIG. 18.

FIG. 20 shows a schematic of thermal dynamic principles applied to reveal flute frequency with infrared imaging sensors according to an example of the present disclosure.

FIG. 21 shows a corrugate wall image with the cold area highlighted for measuring flute frequency over distance according to an example of the present disclosure.

FIG. 22 shows an overhead schematic of a system for cutting objects according to an example of the present disclosure.

FIG. 23 is a flow chart of a method for cutting an object according to an example of the present disclosure.

FIG. 24 is a flow chart of another method for cutting an object according to an example of the present disclosure.

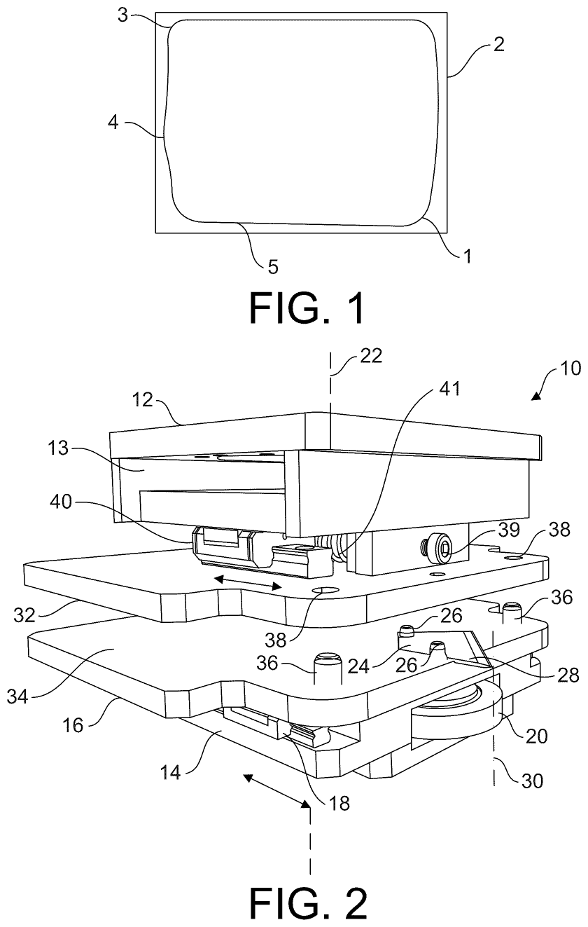

### DETAILED DESCRIPTION

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness.

While various embodiments are described herein, in the interest of clarity all features of an actual implementation may not be described in this specification. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure. It will also be understood that the words “object” “container” and “box” as used herein are meant to be interchangeable and include all types of vessels or housings used for housing, storing, shipping, and/or transporting products.

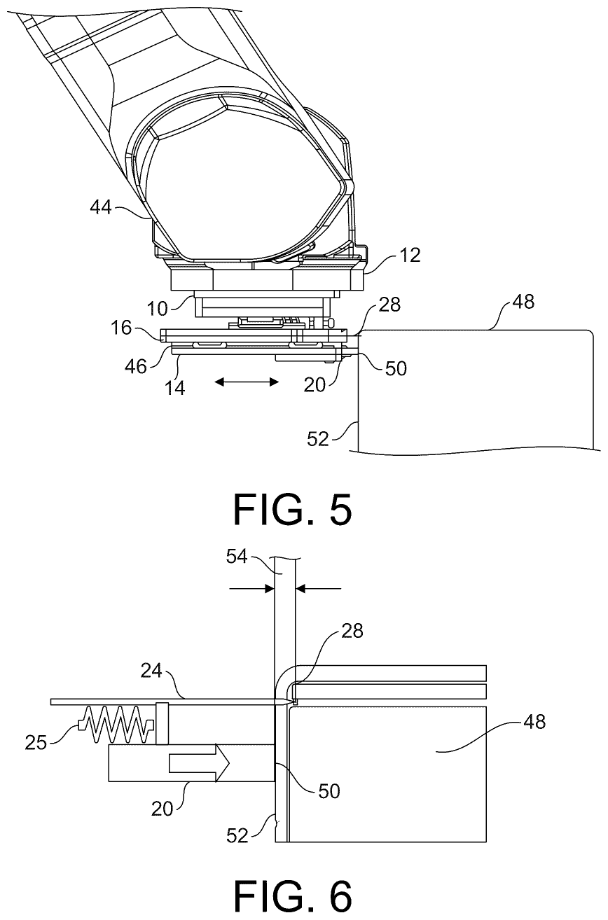

FIG. 2 shows an embodiment of a cutter assembly 10 of this disclosure. At the top of the assembly 10, a manipulator connection plate 12 is configured for engagement to a conventional manipulator arm (44 in FIG. 5). A wireway 13 provides an open area for internal wiring passage. At the bottom of the assembly 10, a first platform 14 is coupled to a second platform 16. The platforms 14, 16 provide planar engagement surfaces. One or more bearings 18 are disposed between the two platforms 14, 16 to allow for movement of the plates with respect to one another. A wheel 20 is linked to the first platform 14. The wheel 20 is disposed horizontally with respect to a longitudinal axis 22 of the assembly 10. The wheel 20 is configured to freely rotate about its axis, which is parallel to the assembly 10 longitudinal axis 22. In some embodiments a spring force adjustment screw 39 is added to preload a compression spring 41 to provide a horizontal compliance feature.

The assembly 10 also includes a third platform 32. FIG. 2 shows the second platform 16 separated from the third platform 32. The upper surface 34 of the second platform 16 is configured with a pair of guiding pins 36 extending outward from the surface. The guiding pins 36 are in alignment with a pair of receiving holes 38 formed on the third platform 32. When joined together, the second platform 16 and the third platform 32 abut against one another guided in alignment by the respective pin 36/hole 38 engagement. One or more bearings 40 are disposed between the third platform 32 and the second platform to 16 permit sliding displacement between the platforms.

A cutting element 24 is linked to the top of the second platform 16 and held in place via a pair of raised holding pins 26. The cutting element 24 terminates at one end with a tip 28 having a sharp cutting edge extending out from the second platform 16. As shown in FIG. 2, the outer contact surface of the wheel 20 is on axis 30 with the tip 28 of the cutting element 24. The outer contact surface of the wheel 20 is configured to make contact with a surface of an object to be cut, as described below.

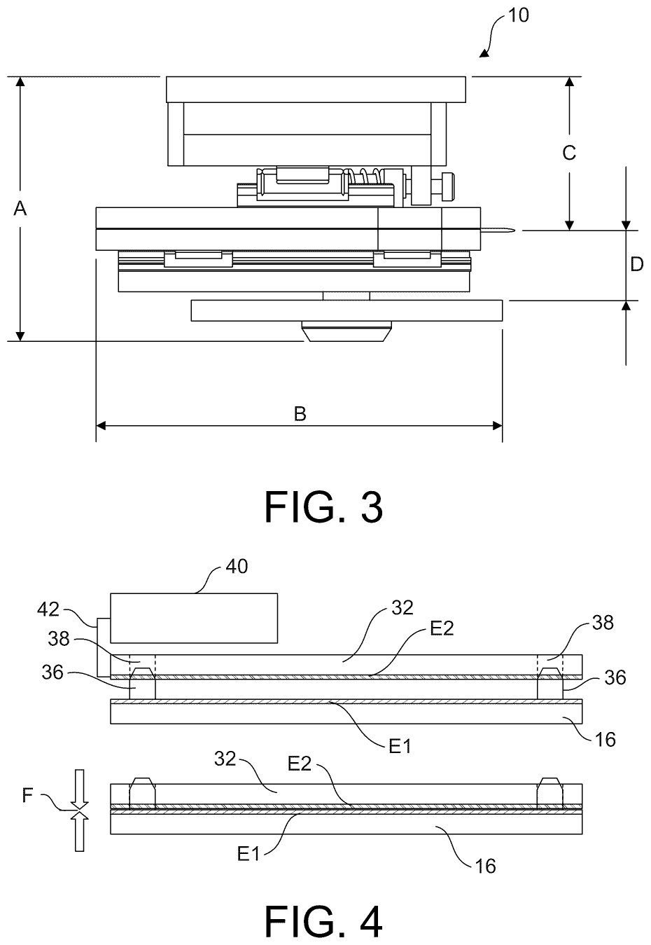

FIG. 3 shows a side view of a cutter assembly 10 embodiment of this disclosure. An advantage of the disclosed assemblies 10 is their compact size. For example, an embodiment may be implemented with an overall height A of 51.3 mm, an overall width B of 104.2 mm, a manipulator connection plate height C of 29.8 mm, and a lower platform stack D height of 13.5 mm. Other embodiments may vary in dimensions.

FIG. 4 shows a cross-section of the second platform 16 of the cutter assembly 10 of FIG. 2 configured with an electrode E1 disposed on the platform surface that mates with the surface of the third platform 32. The third platform 32 is similarly configured with an electrode E2 disposed on the platform surface that mates with the surface of the second platform 16. The pair of electrodes E1, E2 are configured to selectively maintain the second and third platforms 16, 32 in an attractive state or a non-attractive state to one another. The upper schematic in FIG. 4 shows the electrodes E1, E2 in the non-attractive state, which allows the platforms 16, 32 to separate from one another. The lower schematic in FIG. 4 shows the electrodes E1, E2 in the attractive state, which creates a holding force F that keeps the platforms 16, 32 securely engaged to one another. A power supply 40 provides a current to the electrodes E1, E2 via a lead 42 to energize the electrodes to generate an electric field between the electrodes to actuate the attractive state between the platforms 16, 32. When the current is turned off, the electric field collapses and the platforms 16, 32 switch to the non-attractive state. Embodiments of this disclosure can be implemented with conventional energizable electrodes E1, E2, for example as described in U.S. Pat. Nos. 10,554,154, 10,749,450, 10,998,835, 11,023,047, 11,036,295, 2024/0131676, and 2024/0213892.

FIG. 5 shows a schematic of a cutter assembly 10 embodiment of this disclosure. The assembly 10 is coupled to a manipulator 44 engaged to the manipulator connection plate 12. The assembly 10 is implemented with another electrode pair 46 disposed between the first platform 14 and the second platform 16, similar to the electrode pair E1, E2 described above with respect to FIG. 4. The pair of electrodes 46 are configured to selectively maintain the first and second platforms 14, 16 in an attractive state or a non-attractive state to one another as described herein.

FIG. 5 shows the manipulator 44 with the cutter assembly 10 in operation cutting open an object 48 (a box in this case). As shown in FIG. 5, the outer contact surface 50 of the wheel 20 is in contact with a side wall surface 52 of the box 48. Since the first platform 14 is rigidly engaged with the second platform 16, the tip 28 of the cutting element 24 extends outward beyond the contact surface 52 of the wheel 20 for a limited distance. FIG. 6 shows a blown-up schematic of the tip 28 of the cutting element 24 cutting into the box 48 wall to a limited depth 54 of penetration. In some embodiments the assembly includes a spring 25 to provide a horizontal compliance feature.

The autonomous cutting element 24 penetration depth 54 adjustment of the assembly 10 embodiments will now be described. As described with respect to FIG. 4, the implementation of electrode pairs E1, E2 between the platforms 16, 32 allows the platforms to separate from one another when the current is turned off to switch the platforms to a non-attractive state. In the same way, the electrode pair 46 between the first platform 14 and the second platform 16 in the assembly 10 of FIG. 5 permit the platforms to separate from one another to slide in horizontal displacement (as illustrated by the arrow in FIG. 5). By actuating the electrode pair 46 to place the platforms 14, 16 in the non-attractive state, the first platform 14 can be displaced for a selected distance with respect to the second platform 16. Since the wheel 20 is linked to the first platform 14, the limited depth 54 of penetration for the tip 28 of the cutting element 24 can be adjusted accordingly via the displacement of first platform 14 with respect to the second platform 16. Once the desired depth 54 of penetration is set, the electrode pair 46 is actuated to place the platforms 14, 16 in the attractive state, thereby rigidly locking the platforms in engagement with one another. In essence, the electrode pairs E1, E2, 46 implemented with the assembly 10 embodiments act as electric clutches providing for autonomous cutting element 24 penetration depth 54 adjustment and cutting element 24 replacement (further described below). The depth adjustment and cutting element 24 replacement can be performed autonomously by the manipulator 44 as described herein.

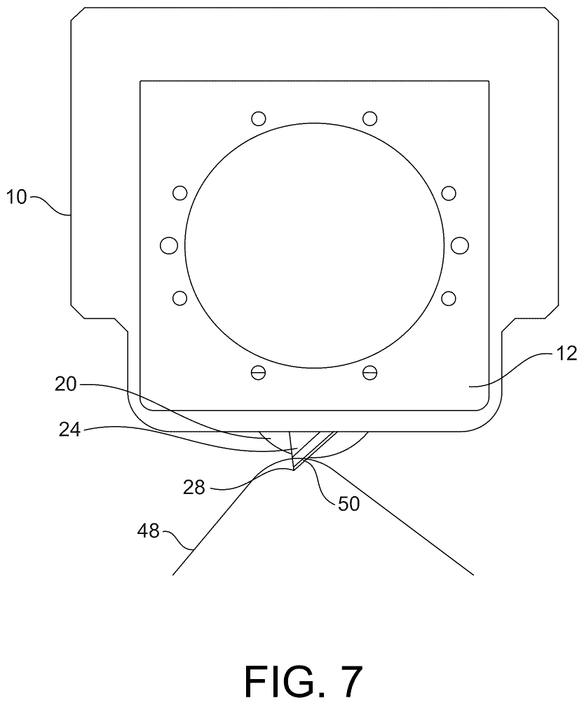

FIG. 7 shows an overhead view of a cutter assembly 10 embodiment engaged to cut a rounded corner of an object 48. As shown, the cutting element 24 is in axial alignment with the contact surface 50 of the wheel. As the manipulator 44 moves the assembly 10 around the object 48, the tip 28 of the cutting element 24 remains extended for the selected distance to maintain the fixed penetration depth 54 (see FIG. 6).

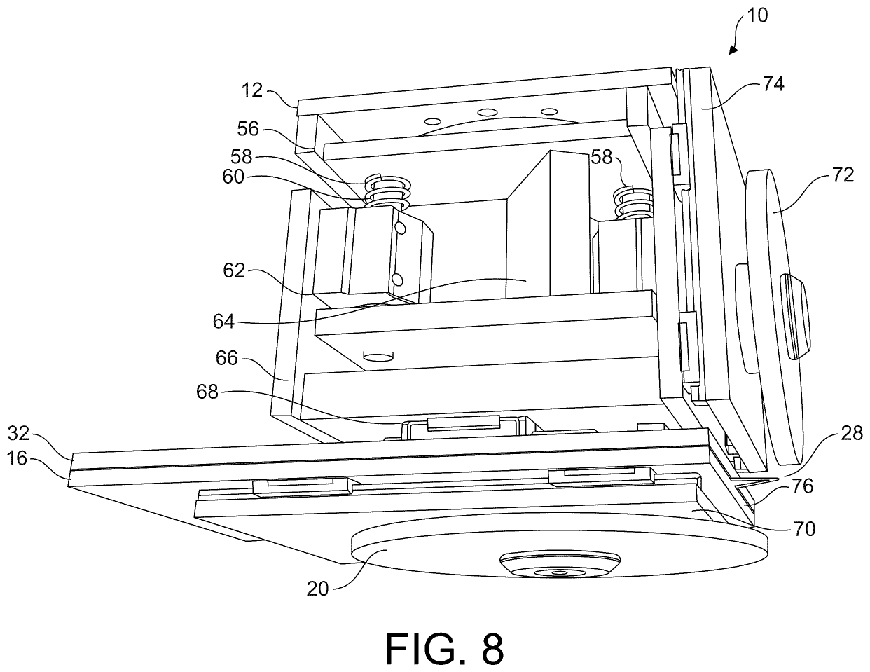

FIG. 8 shows another embodiment of a cutter assembly 10 of this disclosure. The assembly 10 is configured with a manipulator connection plate 12, A wireway block 56 to provide a pathway for internal wiring, vertical compliance springs 58, a vertical compliance bearing rail 60, vertical bearing blocks 62, a bearing block spacer 64, a vertical spring housing 66, horizontal compliance bearings 68, and a horizontal contact wheel 20 linked to a horizontal electric positioning clutch 70. This embodiment also includes a vertical contact wheel 72 linked to a vertical electric positioning clutch 74. The platforms 16, 32 may also be configured with a cutting element 24 replacement electric clutch 76. The electric clutches 70, 74, 76 consist of the energizable electrode pairs disclosed herein to permit sliding displacement of the respective platforms.

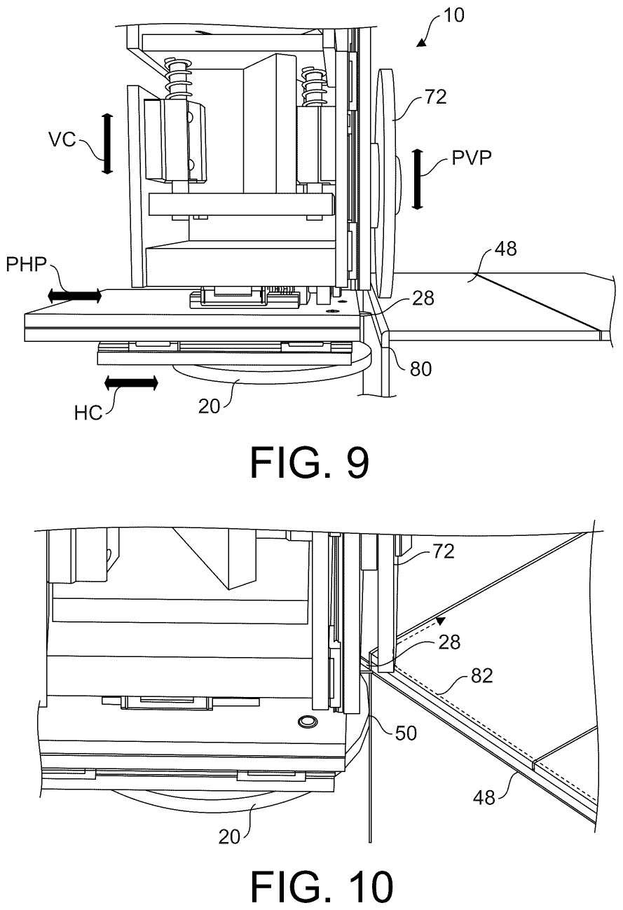

FIG. 9 shows the assembly 10 of FIG. 8 in operation with the cutting element 24 cutting the object 48 along a cut line 80. The arrows represent the vertical compliance VC, horizontal compliance HC, programmed vertical position PVP, and programmed horizontal position PHP provided by the assembly 10. The PVP and PHP are further described herein.

FIG. 10 shows the assembly 10 of FIG. 8 with the vertical wheel 72 making contact with an upper surface of a container 48 along a travel line 82 making a turn. The horizontal wheel 20 is making contact 50 with a side surface of the container 48. The dual axis contact points provided by the wheels 20, 72 and the single-line contact of the cutting tip 28 is highly suited for fast motion around the corner of the container 48.

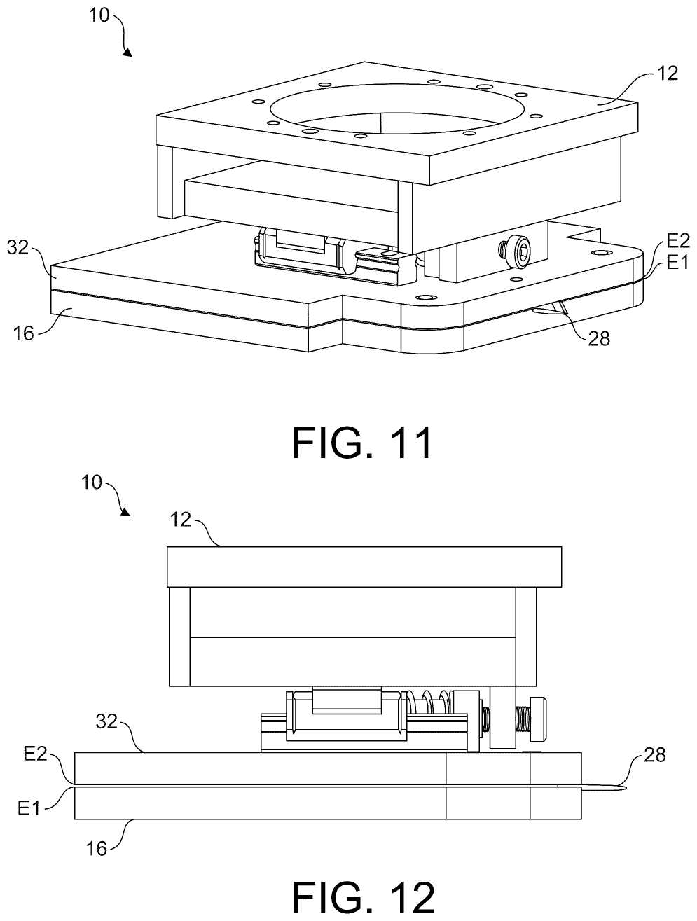

FIG. 11 shows a schematic of a cutter assembly 10 embodiment similar to the assembly of FIG. 2. The assembly of FIG. 11 is configured without a wheel structure. Although the platforms 16, 32 in FIG. 11 are shown configured with linear sides, other assembly 10 embodiments may be implemented with rounded sides. FIG. 12 shows a side view of the assembly 10 of FIG. 11.

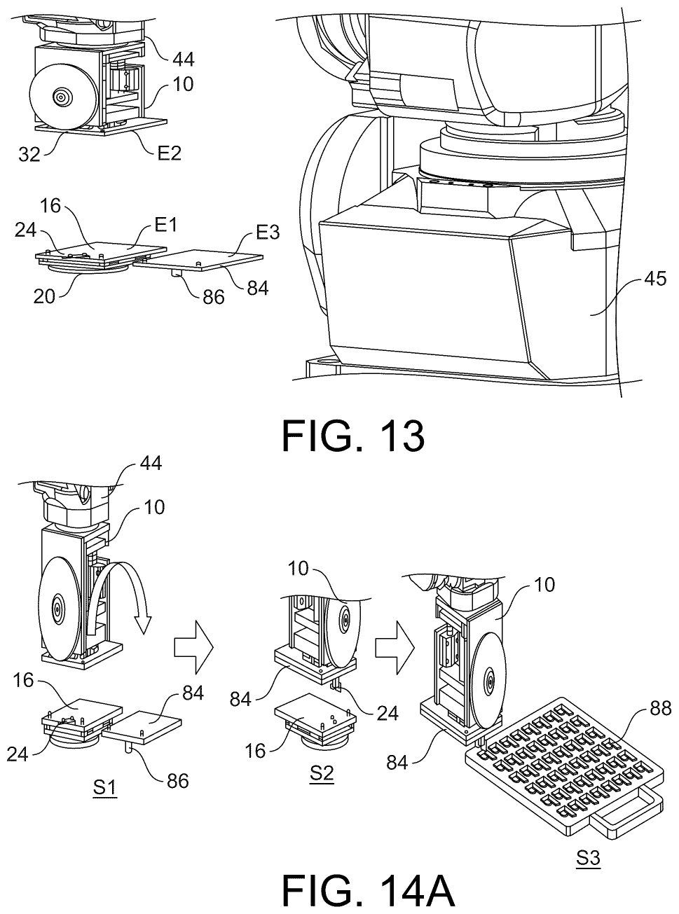

FIG. 13 shows a schematic of a cutter assembly 10 embodiment configured for automatic and autonomous replacement of the cutting element 24 at the blade level on the end of arm tooling. The assembly 10 is coupled to a manipulator 44 arm extending from a base 45. With the platforms 16, 32 configured with electrodes E1, E2 as described with respect to FIG. 4, the manipulator 44 can autonomously actuate the electrodes to place the platforms in the non-attractive state to allow the platforms to separate. Once the platforms 16, 32 separate, the cutting element 24 is exposed (see FIG. 2). The manipulator 44 is programmed to temporarily place the second platform 16 down and engage a cutting element changing platform 84 configured with an electrode E3 disposed on its upper surface. The manipulator 44 autonomously actuates the electrode E2 on the third platform 32 with the power source 40 (see FIG. 4) to attract the electrode E3 and engage the cutting element changing platform 84. The cutting element changing platform 84 is configured with a gripper 86 on its bottom surface. The gripper 86 is configured to grab the exposed cutting element 24 from the top of the second platform 16 for replacement.

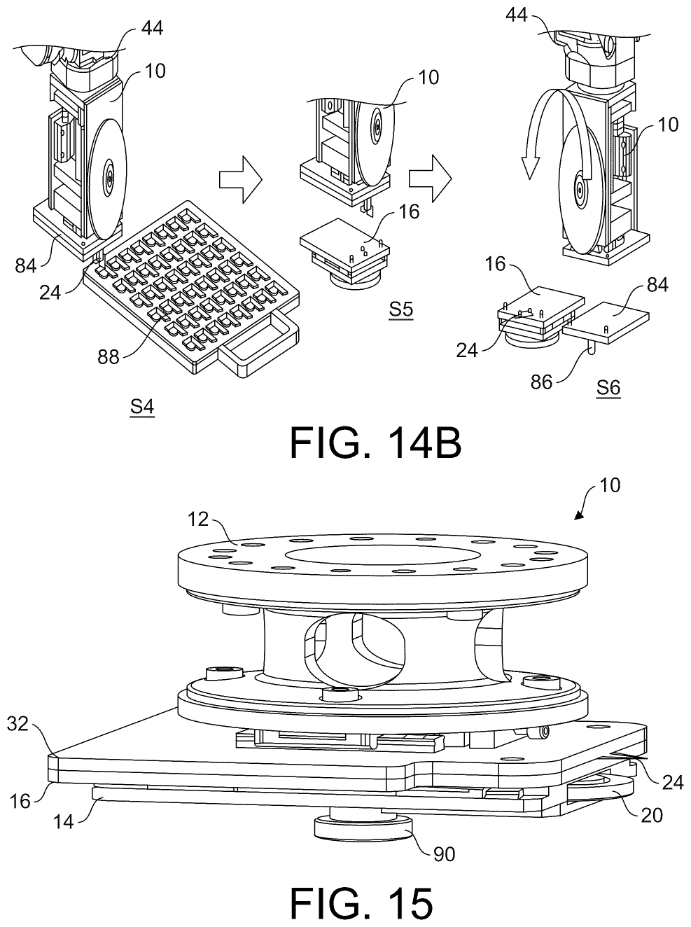

FIG. 14A shows a sequence of events for autonomous replacement of the cutting element 24 from cutting assembly 10 embodiments. At a first step S1 the lower half of the assembly 10 is separated as described herein, leaving the cutting element 24 exposed. At a second step S2 the manipulator 44 moves to engage the cutting element changing platform 84 as described herein, and picks up the worn cutting element 24 from the second platform 16 using the gripper 86. At a third step S3 the manipulator carries the worn cutting element 24 and places it in a tray 88. Turning to FIG. 14B, at a fourth step S4 the gripper 86 is then used to pick up a fresh cutting element 24 from the tray 88. At step five S5 the fresh cutting element 24 is set on the open face of the second platform 16. At step six S6 the manipulator 44 drops off the cutting element changing platform 84 and reengages with the second platform 16 to resume cutting operations with a fresh cutting element 24.

FIG. 15 shows another cutter assembly 10 embodiment of this disclosure. This embodiment is similar to the other assembly 10 embodiments with the exception of a screw 90 traversing through the bottom of the assembly for adjusting the depth 54 of penetration (see FIG. 6) of the cutting element 24 in the horizontal plane. By using the mechanical compression force of the screw 90 to hold the first and second platforms 14, 16 together the element 24 depth can be selectively adjusted. This process can be carried out autonomously by the manipulator 44 positioning the assembly 10 to a torque station and engaging the compression screw 90 with a torque socket. The screw or bolt 90 is loosened, freeing the first and second platforms 14, 16 to move linearly about each other. The manipulator 44 moves the bolt 90 linearly connected with the platforms 14, 16 to a new cut depth setting, then re-torquing the bolt to lock the new cut depth setting in place.

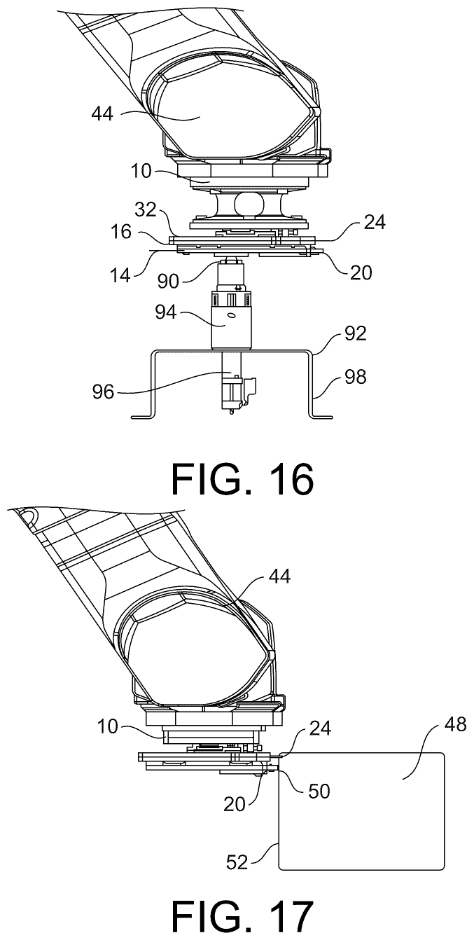

FIG. 16 shows the assembly 10 of FIG. 15 in position at a torque station 92. The manipulator 44 positions the bolt 90 in engagement with a torque limiter 94 couped to a gear motor 96 configured to loosen the bolt when cutter 24 depth adjustment is desired. After loosening the bolt 90, the manipulator 44 moves the first platform 14 laterally to set the desired cutter element 24 depth. The torque station 92 may be secured in place via a mounting frame 98. Once the desired cutter 24 depth is set the torque limiter 94 tightens the bolt 90 to a set torque to securely maintain the first and second platforms 14, 16 locked in engagement. FIG. 17 shows the manipulator 44 in operation with the cutter assembly 10 traversing the side walls of a box 48 along a cutting line after the cutter 24 depth 54 of penetration (see FIG. 6) is set via the torque station 92.

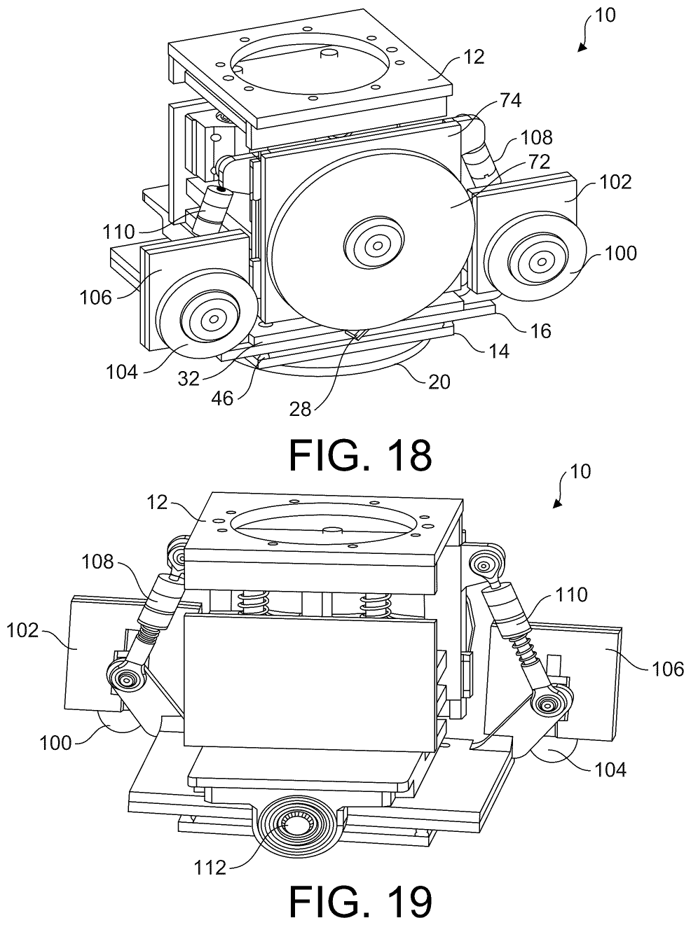

FIG. 18 shows another cutter assembly 10 embodiment of this disclosure. This assembly 10 is configured similar to the other disclosed embodiments, with additional features. In addition to the horizontal wheel 20, this assembly 10 includes a vertical contact wheel 72 linked to a vertical electric positioning clutch 74. The first and second platforms 14, 16 are also configured for linear displacement via a horizontal electric positioning clutch 46. A second vertical contact wheel 100 is disposed on one side of the center vertical contact wheel 72 and linked to a vertical electric positioning clutch 102. A third vertical contact wheel 104 is disposed on the other side of the center vertical contact wheel 72 and linked to a vertical electric positioning clutch 106. The first, second, and third vertical contact wheels 72, 100, 104 are disposed with their respective axes in the same plane of rotation.

FIG. 19 shows a rear view of the assembly of FIG. 18. The axis of the second vertical contact wheel 100 is coupled to a first suspension linkage 108 linked at one end to the assembly 10 frame and to the platforms 16, 32 at the other end. The axis of the third vertical contact wheel 104 is coupled to a second suspension linkage 110 linked at one end to the assembly 10 frame and to the platforms 16, 32 at the other end. The first, second, and third vertical contact wheels 72, 100, 104 are disposed to automatically enable the second and third vertical wheels to maintain contact with the surface of the object even when the surface is at an angle or inclination. The platforms 14, 16, 32 pivot about a central bearing 112, allowing the suspension linkages 108, 110 to automatically tilt the platforms as the vertical wheels 100, 104 maintain contact with an inclined surface of the container. As the platforms 14, 16, 32 pivot and tilt, the tip 28 of the cutting element 24 correspondingly tilts to maintain a cutting line along the angled or inclined surface of the object being cut.

An essential function of accurately opening unknown objects 48 such as boxes is determining the wall thickness of the box. Conventional boxes are formed with corrugate walls. Corrugated wall thickness can be calculated from the manufacturing standards of the various flute sizes used in shipping container construction. The corrugated wall is calculated by measuring the internal flute frequency over a longitudinal distance. The hidden flute may be detected by a surface relief or infrared detection sensor. In some embodiments of this disclosure, infrared detection is implemented as it offers a means of measurement when surface details are absent and does not require lighting changes for different flute orientations. The infrared solution images the peak of the crest of the internal corrugated flute using the laws of thermal dynamics.

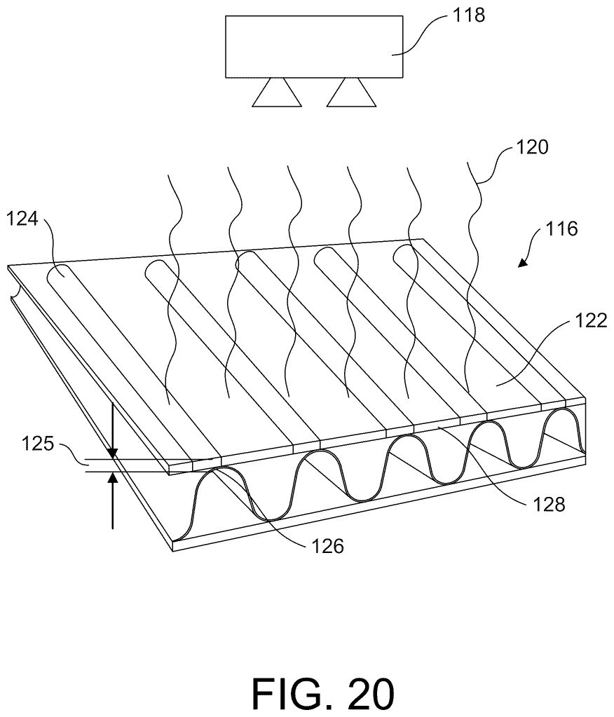

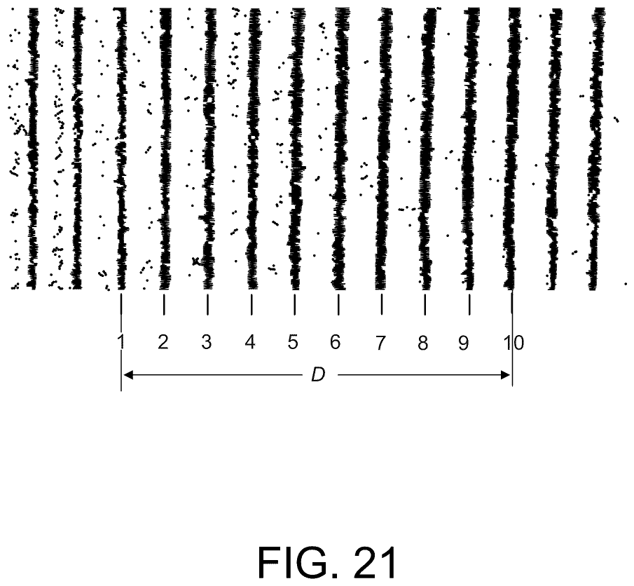

FIG. 20 shows a corrugated wall segment 116 of a box 48. The segment 116 is exposed to a short-term momentary infrared source 118, heating the box surface. A sensor 118 sensitive to the IR radiation 120 emitted from the container surface captures an image over a calibrated space, revealing hotter surface regions 122 and colder surface regions 124. The colder region 124 exists where the flute crest is glued to the outer paper. These regions are imaged as colder because the increased density of material (higher density cross-section 125) provides a higher heat sink 126 where the flute is in contact with the paper and can absorb more radiation than the surrounding thinner paper where there is less thermal mass 128. Thus the colder regions 124 reveal the internal flute frequency. Conventional infrared sources and sensors may be used to implement embodiments of this disclosure.

FIG. 21 shows a corrugate wall image with the cold area highlighted for measuring flute frequency over distance. With the corrugate thickness measured from an unknown object 48, the disclosed cutter assembly 10 embodiments can automatically and autonomously configure themselves to achieve a very accurate cut by tracing the walls of the object 48 over the areas where the cut occurs.

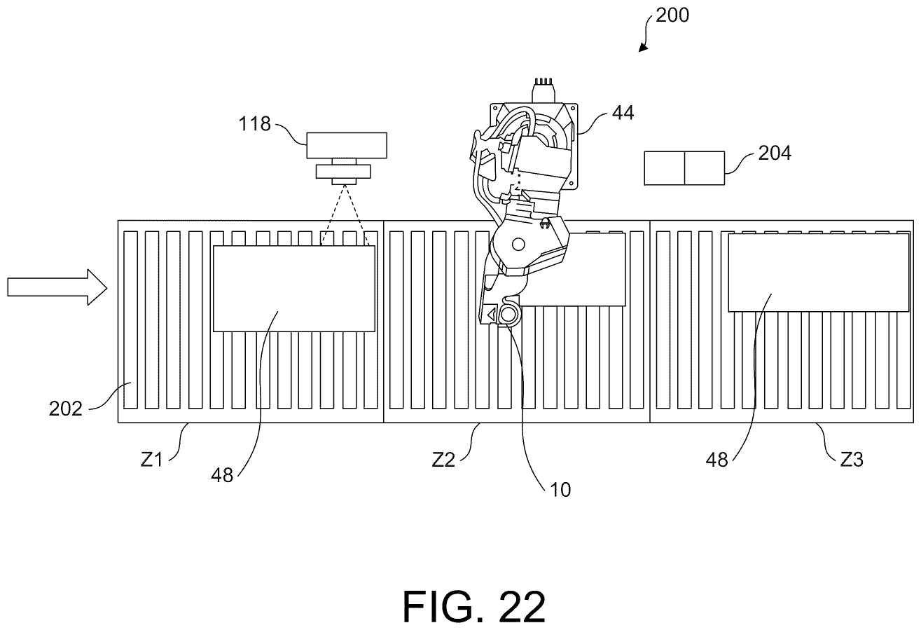

FIG. 22 shows an overhead view of a system 200 for cutting objects. The system 200 includes general operation zones. The flow of container 48 movement is from left to right as indicated by the arrow. A corrugate container 48 moves into a first zone Z1 along a conveyor 202. In the first zone Z1 a flute measurement and light source 118 makes the flute measurement to determine the container 48 flute frequency. Once the container 48 flute frequency is determined, the manipulator 44 automatically and autonomously positions the cutter assembly 10 at a tool configuration stop 204. At the configuration stop 204, the electric clutch is automatically actuated to adjust the cutter 24 penetration depth (see FIG. 6), as disclosed herein, in accordance with the determined container 48 flute frequency parameters. The automatic setting of this cutter “recipe” includes determination of the height the manipulator 44 is to raise and hold the coupled cutter assembly 10 to ensure the cutter element 24 cuts the container 48 at the correct height position. The cutter recipe is automatically established before the container 48 moves into the second zone Z2. Once in the second zone Z2, the manipulator 44 positions the coupled cutter assembly 10 according to the recipe and rapidly rotates the assembly around the container 48 to cut open the container at the appropriate penetration depth 54. After the container 48 is cut open, the container moves into the third zone Z3 for additional handling. It will be appreciated by those skilled in the art that additional conventional technology may be included in embodiments of the system 200 to determine additional container dimensions that can be incorporated in determination of the cutter recipe to adjust the cutter element 24 as described herein.

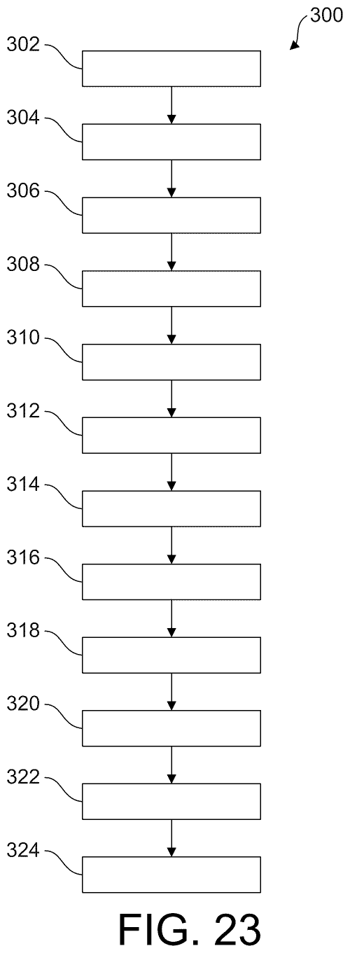

FIG. 23 is a flow chart of a method 300 for cutting an object in accordance with embodiments of this disclosure. In some implementations, the methods may be carried out with a system 200 such as illustrated in FIG. 20 and cutter assembly 10 embodiments as shown in FIG. 2. At step 302 an unknown object arrives at Zone 1. At step 304 the flute frequency is measured by a sensor. At 306 the position of the cut line and cut depth are calculated. At 308 the unknown object is conveyed to Zone 2. At 310 during the conveyance, the manipulator moves the cutter assembly to a hard stop. At 312 the electric linear clutch on cut depth axis is released. At 314 the manipulator moves the cut depth axis to the proper setting. At 316 the linear clutch on cut depth is locked. At 318 the cutter assembly is configured for accurate cuts on the object presented. At 320 the unknown object is positioned and measured by conventional technologies determining a path around the object. At 322 the configured cutter assembly is moved around the object periphery to cut the prescribed number of sides. At 324 the configured cutter assembly maintains the cut depth absorbing errors by the manipulator path.

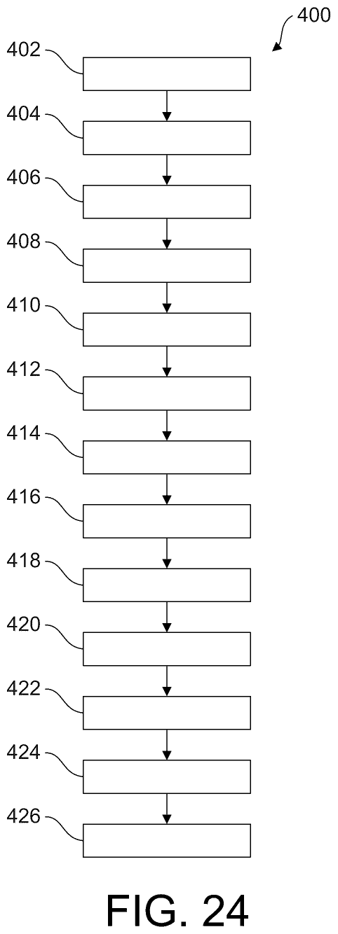

FIG. 24 is a flow chart of another method 400 for cutting an object in accordance with embodiments of this disclosure. In some implementations, the method may be carried out with a system 200 such as illustrated in FIG. 20 and cutter assembly 10 embodiments as shown in FIG. 8. At step 402 an unknown object arrives at Zone 1. At 404 the flute frequency is measured by a sensor. At 406 the position of the cut line and cut depth are calculated. At 408 the unknown object is conveyed to Zone 2. At 410 during the conveyance, the manipulator moves the cutter assembly to a hard stop. At 412 the electric linear clutches on cut depth and cut height axes are released. At 414 the manipulator moves the cut depth axis to the proper setting. At 416 the manipulator moves the cut height axis to the proper setting. At 418 the linear clutches on cut depth and cut height are locked. At 420 the cutter assembly is configured for accurate cuts on the object presented. At 422 the unknown object is positioned and measured by conventional technologies determining a path around the object. At 424 the configured cutter assembly is moved around the object periphery to cut the prescribed number of sides. At 426 the configured cutter assembly maintains the cut depth absorbing errors by the manipulator path.

The software code used by the manipulators 44 and cutter assembly 10 embodiments may be implemented using conventional programming languages as known in the art (e.g., JAVA™, PYTHON™, C, C++, etc.). It will be appreciated by those skilled in the art that application programming for the disclosed embodiments may be implemented with a single software program or a group of programs designed to perform the processes disclosed herein. The architecture may be implemented with conventional computer technologies.

Advantages of the disclosed embodiments include: the capability to detect and calculate the optimum three-dimensional cut path and cut depth to avoid damage to contents on unknown containers and content as they arrive at the system, eliminating the requirement for cut details or pre-determined recipes stored for thousands of box sizes; automatically and autonomously configuring the cutting assemblies for each different container to the optimum cut path and cut depth calculated; execution of a cut path with the accuracy required that will not damage container contents over an extensive range of container sizes; execution of a controlled and consistent cut depth with the accuracy required not to damage contents over an extensive range of corrugate thickness and box configurations; automatic and autonomous replacement of worn cutting elements to keep the automation running without pausing machine operation to manually replace cutting element tools; eliminating manual handling of sharp blades or cutting elements in or outside the box-opening machine; providing a cutting tool with all the functions mentioned that is a lightweight, small, and nimble solution capable of being manipulated around small and large containers; providing a design with technology that reduces system cost and tooling bulk by performing precision motion functions through the use of existing servo motion within the manipulator that moves the tooling with the containers; automatically sensing internal corrugated box wall structures and calculating the optimum cutting parameters to open containers without damaging their contents; automatically reconfiguring itself to the optimum cut settings for each container presented; automatically absorbing errors in the manipulator path while accurately matching and tracking contours in shipping container walls and around the radii of container corners with high-speed motion on an extensive range of container sizes.

Embodiments of the cutter assemblies average the container wall distortion to prevent issues with the cutting element while maintaining an on-axis precision that tracks the cutting element around corners and accurately tracks defects in the container walls. The end-of-arm tooling automatically replaces its cutting elements when worn without requiring manual help to handle cutting elements on replacement tool heads in or outside of the machine.

The disclosed system embodiments receive unknown corrugated containers or boxes and open the containers without damaging contents. Shipping containers are opened automatically by a manipulator or robot moving a cutter assembly along the container top on three or four sides. To avoid damage to the contents, the container is cut just deep enough to penetrate the side wall thickness at a horizontal cut path near the bottom side of the container's top within about 0.5 mm of the actual container surfaces. These settings are set automatically and autonomously for each arriving container in relation to the corrugate wall thickness measured by the disclosed embodiments.

In light of the principles and example embodiments described and illustrated herein, it will be recognized that the example embodiments can be modified in arrangement and detail without departing from such principles. For example, alternative embodiments may include processes that use fewer than all of the disclosed operations, processes that use additional operations, and processes in which the individual operations disclosed herein are combined, subdivided, rearranged, or otherwise altered. It will also be appreciated that the hardware and components of the disclosed embodiments may be implemented using conventional materials as suitable for the particular application (e.g., metallic, composites, synthetic materials, plastics, etc.). In view of the wide variety of useful permutations that may be readily derived from the example embodiments described herein, this description is intended to be illustrative only, and should not be taken as limiting the scope of the invention.

What is claimed is:

1. An assembly for cutting objects, comprising:
a platform;
a cutting element linked to the platform;
the platform configured with an electro-actuation clutch for selective movement of the platform; and
wherein movement of the platform via actuation of the electro-actuation clutch enables manipulation of the cutting element.

2. The assembly of claim 1, wherein the electro-actuation clutch comprises an electrode arrangement configured to selectively maintain elements of the platform in an attractive or a non-attractive state.

3. The assembly of claim 1, wherein the electro-actuation clutch enables multi-axis movement of the platform.

4. The assembly of claim 1, wherein the platform is configured for engagement to a manipulator arm.

5. The assembly of claim 1, wherein the platform is configured for autonomous replacement of the cutting element.

6. The assembly of claim 1, wherein the manipulation of the cutting element includes alteration of a depth parameter associated with the element.

7. The assembly of claim 1, further comprising a sensor to determine a wall thickness of the object.

8. The system of claim 7, wherein the sensor comprises a processor configured to compute a flute frequency associated with the object based on infrared radiation detected from a surface of the object.

9. The assembly of claim of claim 1, further comprising at least one wheel linked to the platform to enable compliance on at least one axis of the platform.

10. The assembly of claim of claim 1, wherein the platform is configured for multi-axis compliance.

11. A method for cutting objects, comprising:
actuating an electro-actuation clutch to selectively move a platform,
wherein movement of the platform enables manipulation of a cutting element linked to the platform;
setting the platform proximate an object; and
cutting a surface of the object with the cutting element.

12. The method of claim 11, wherein the cutting the surface of the object comprises calculation of a cut path for the object in real time.

13. The method of claim 11, further comprising determining a wall thickness of the object prior to the cutting the surface of the object.

14. The method of claim 11, further comprising engaging the platform to a manipulator configured to autonomously replace the cutting element.

15. The method of claim 11, further comprising determining a flute frequency associated with the object prior to the cutting the surface of the object.

16. The method of claim 11, wherein the cutting the surface of the object comprises moving the platform along a path on the object to cut off a section of the surface.

17. The method of claim 11, wherein the electro-actuation clutch comprises an electrode arrangement configured to selectively maintain elements of the platform in an attractive or a non-attractive state.

18. The method of claim 11, wherein the manipulation of the cutting element includes alteration of a depth parameter associated with the element.

19. A method for cutting objects, comprising:
determining a wall thickness of an object;
calculating a cutting path for the object in real time based on the determined wall thickness; and
manipulating a platform configured with a cutting element to cut the object along the calculated cutting path.

20. A tool, comprising:
a body configured for engagement to a manipulator; and
at least one wheel to enable compliance of the tool using a rolling contact surface.

21. A tool, comprising:
a body configured for engagement to a manipulator,
wherein compliance of the tool on at least one axis is controllable via an electromagnetic force actuated on the body.

22. A tool, comprising:
a multi-member body configured for engagement to a manipulator,
wherein at least one member of the body can be changed using capacitive stiction force to grip and release different members of the multi-member body.

23. A tool, comprising:
a body configured for engagement to a manipulator;
the body configured for compliance on at least one axis; and
a cutting element linked to the body,
wherein a depth parameter associated with the cutting element can be altered.

24. A tool, comprising:
a body configured for engagement to a manipulator; and
a cutting element linked to the body,
wherein the body is configured for autonomous replacement of the cutting element.
